(19) United States
(12) Patent Application Publication
(10) Pub. No.: US 2024/0276950 A1
(43) Pub. Date: Aug. 22, 2024

(54) Pet Feeding Outfit

(71) Applicant: Melissa Coale, Middletown, DE (US)

(72) Inventor: Melissa Coale, Middletown, DE (US)

(21) Appl. No.: 18/170,635

(22) Filed: Feb. 17, 2023

(51) Int. Cl. A01K 5/01

(52) U.S. Cl. CPC A01K 5/0107

(57) ABSTRACT

A pet feeding outfit has a first container with an open top and laterally extending attachment tabs, a second open top container which is smaller in size than the first container and configured to be inserted into and positioned within the first open top container, and an enclosed canteen shaped third container configured to be inserted and positioned within the second container. The third container has a canteen cap for closure of its open top spout and laterally extending attachment tabs. Attachment clamps are configured to be positioned around each of the attachment tabs of the first and third containers to secure the first, second, and third containers in a nested state. The attachment clamps are removeable to allow the containers to be separated and utilized independently of each other.

### FIELD OF THE INVENTION

The present invention generally relates to products for pets and more particularly to products which assist in the feeding of pets.

### BACKGROUND OF THE INVENTION

Pets, especially dogs and cats, are routinely fed by adding pet food and water to bowls, deep dishes, or similar containers. Several of such containers are usually necessary at one feeding to hold different pet food and water. While the use of a plurality of containers will not ordinarily present a problem at home, when one is traveling with a pet, transporting different containers, along with the pet's food, becomes cumbersome and inconvenient.

There are currently no means which provides a pet food container system which is compact, portable, and easy to use and specifically designed to address the problem of feeding pets while away from home.

### SUMMARY OF THE INVENTION

It is thus the object of the present invention to provide a pet feeding outfit which addresses the absence of such pet feeding systems and overcomes the limitations and disadvantages of prior means of providing food to feed pets.

These and other objects are accomplished by the present invention, a pet feeding outfit having a first container with an open top and laterally extending attachment tabs, a second open top container which is smaller in size than the first container and configured to be inserted into and positioned within the first open top container, and an enclosed canteen shaped third container configured to be inserted and positioned within the second container. The third container has a canteen cap for closure of its open top spout and laterally extending attachment tabs. Attachment clamps are configured to be positioned around each of the attachment tabs of the first and third containers to secure the first, second, and third containers in a nested state. The attachment clamps are removeable to allow the containers to be separated and utilized independently of each other.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an exploded view of the components of the pet feeding outfit of the present invention.

FIG. 2 is a top view of the pet feeding outfit of the present invention in its nested state.

FIG. 3 is a section view taken from FIG. 2.

FIG. 4 is a front view of an attachment clamp of the pet feeding outfit of the present invention.

FIG. 5 is a rear view of an attachment clamp of the pet feeding outfit of the present invention.

FIG. 6 is a front view of the pet feeding outfit of the present invention in its nested state.

FIG. 7 is a perspective view of the pet feeding outfit of the present invention in its nested state.

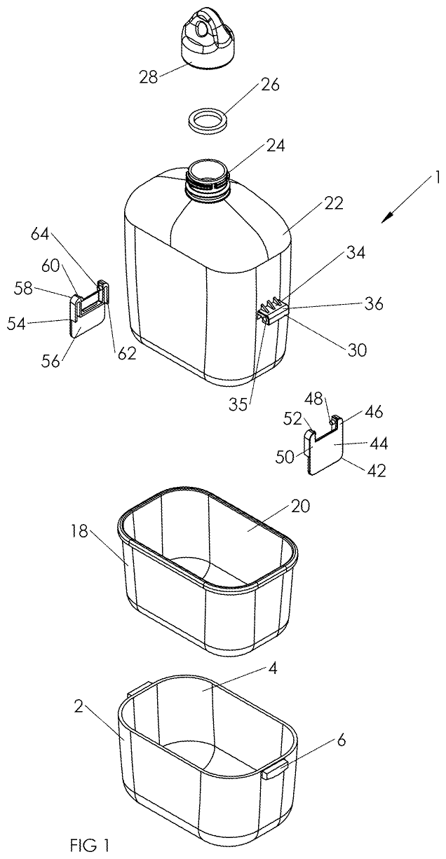

### DETAILED DESCRIPTION OF THE INVENTION

The pet feeding outfit 1 of the present invention comprises first container 2 having open top 4 and laterally extending attachment tabs 6 and 8, located on opposite sides of the container, and second container 18 having open top 20. Container 18 is smaller in size than and is configured to be inserted inside and positioned within first container 2.

Pet feeding outfit 1 also comprises enclosed canteen shaped third container 22 having open top spout 24, sealing gasket 26 and canteen cap 28 for closure of the spout. Laterally extending upper attachment tabs 30 and 32 are located on opposite sides of container 22. Tab 30 has horizontally extending section 34 and vertically extending section 36 with through channel 35 which is open at each end, and tab 32 has horizontally extending section 38 and vertically extending section 40 with a through channel, not shown, but identical to channel 35 in tab 30. Container 22 is configured to be inserted and positioned within container 18.

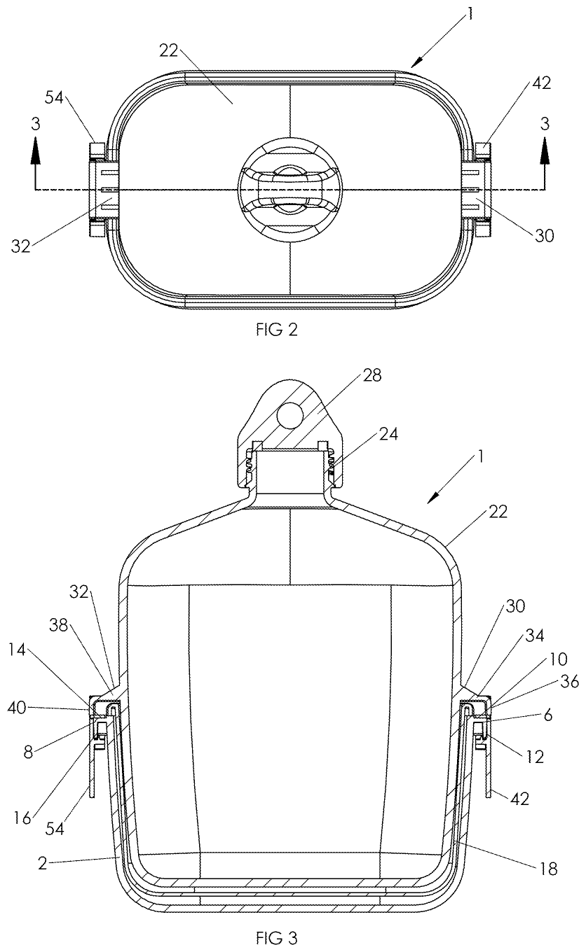

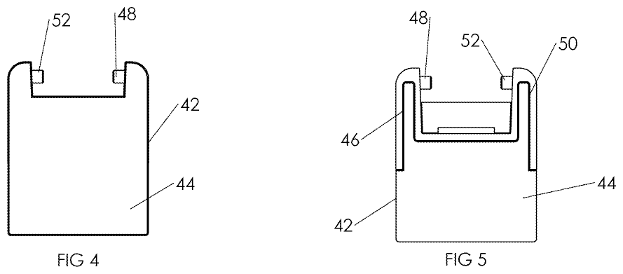

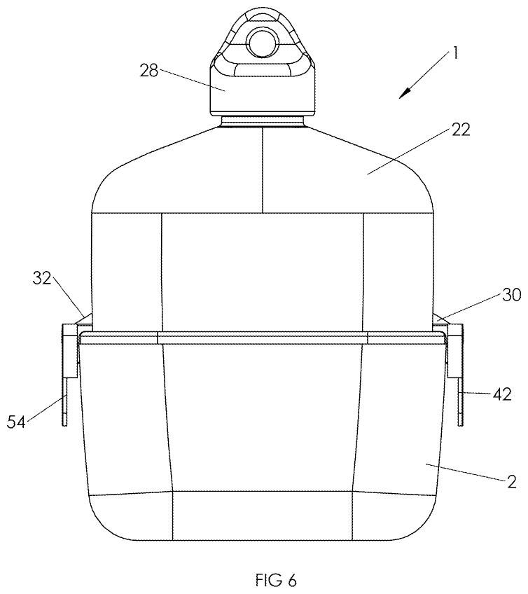

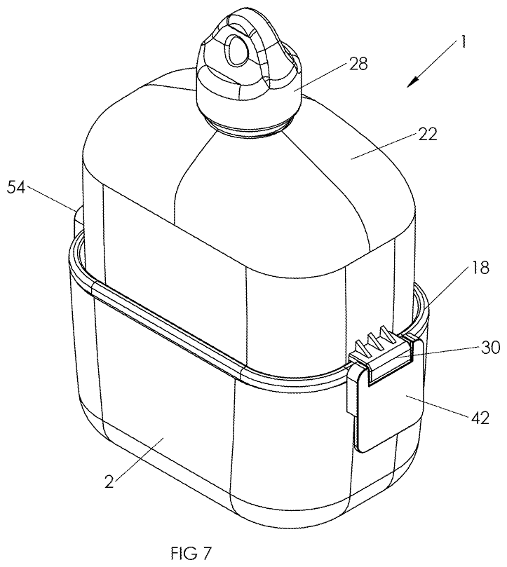

Attachment clamps 42 and 54 are configured to secure first container 1, second container 18, and canteen shaped third container 22 together in a nested state, as best seen in FIGS. 3, 6, and 7. Clamp 42 comprises main body 44 and side section 46 with inwardly extending pin 48 and side section 50 with inwardly extending pin 52. Similarly, clamp 54 comprises main body 56 and side section 58 with inwardly extending pin 60 and side section 62 with inwardly extending pin 64.

In order to secure and maintain first container 1, second container 18, and canteen shaped third container 22 in a nested state such that it is in a stored setting, upper attachment tabs 30 and 32 of the third container are positioned over and overlap attachment tabs 6 and 8 of the first container. Attachment clamps 42 and 54 are then positioned around tabs 30 and 32 respectively such that pins 48 and 52 are inserted into channel 35 of attachment tab 30 and pins 60 and 64 are inserted into the channel of attachment tab 32. Once clamps 42 and 54 are so positioned, containers 2, 18, and 22 of pet feeding outfit 1 are secured in the nested state, and into a single, compact, easy to carry unit.

When attachment clamps 42 and 54 are removed from attachment tabs 6, 8, 30 and 32, the three containers are detached and can be separated, to be used independently of each other, and prepared for feeding a pet in the use setting.

It is contemplated that first container 2 will be fabricated of plastic, to be filled with pet food. Second container 18 will be fabricated of metal and also used for pet food or for water, both of which can be supplied from within canteen shaped third container 22. Of course, the manner of use of each container is not so restricted and can be varied, depending on the need of the user.

Therefore, by the present invention, a compact pet feeding outfit is provided which is portable, easy to use, versatile, and adaptable to feeding a wide variety of pets.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A pet feeding outfit comprising:
a first container having an open top and laterally extending attachment tabs;
a second open top container, smaller in size than and configured to be inserted into and positioned within the first open top container;
an enclosed canteen shaped third container having an open top spout, a canteen cap for closure of the spout, and laterally extending attachment tabs, the third container being configured to be inserted and positioned within the second container;
wherein in a stored setting, the first container is positioned within the second container and the second container is positioned within the third container such that the containers are in a nested state with the tabs of the third container overlapping the tabs of the first container, and in a use setting, the containers are detached and separated, to be utilized independently of each other; and
an attachment clamp configured to be positioned around each of the attachment tabs of the first and third containers to secure the first, second, and third containers in the nested state.

2. The pet feeding outfit as in claim 1 wherein the first container is fabricated of plastic.

3. The pet feeding outfit as in claim 1 wherein the second container is fabricated of metal.

4. The pet feeding outfit as in claim 1 wherein the third container is fabricated of plastic.

5. The pet feeding outfit as in claim 1 wherein the attachment tabs of the third container each have through channels and each attachment clamp has inwardly extending pins configured to be inserted into the channels of the attachment tabs when the first, second and third container are secured in the nested state.
